(19) United States
(12) Patent Application Publication
(10) Pub. No.: US 2007/0173088 A1
(43) Pub. Date: Jul. 26, 2007

(54) Electrical connector

(75) Inventors: Tsu-Yang Wu, Tu-Cheng (TW); Sheng-Ko Chen, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/656,080

(22) Filed: Jan. 22, 2007

(30) Foreign Application Priority Data
Jan. 20, 2006 (TW) 95201388

(51) Int. Cl. H01R 13/44

(52) U.S. Cl. 439/135

(57) ABSTRACT

An electrical connector (1) comprises an insulative housing (2) comprising plurality of passageways (25) thereon, a plurality of electrical terminals (4) received in the housing (2), a cover (5) mounted on the housing (2), wherein the cover (5) includes a number of formable members (52) extending from an inner sidewall thereof for supporting the housing (2), hence preventing the housing (2) from destroying terminals (4).

### BACKGROUND OF THE INVENTION

1. Field of the Invention

The present invention relates to the art of electrical connectors, and more particularly to an electrical connector provided for connecting an electrical applications to a printed circuit board (PCB).

2. Description of the Prior Art

Electrical connectors are widely used in the connector industry for electrically connecting applications to printed circuit boards (PCBs) in personal computer or other consumer electrical equipments. Conventionally, an electrical connector mainly comprises an insulative housing, a multiplicity of terminals received therein, an anchoring hook, a cover mounted on the housing. The housing defines a plurality of receiving passageways for receiving terminals therein. When assembled, the terminals are inserted into the passageways of the housing, and then the cover is mounted above the housing. In this case, the electrical connector is usually positioned on the printed circuit board by a vacuum suction device vacuuming an upper surface of the cover.

However, in the electrical connector abovementioned, the cover is conventional not accurately locating on the housing, and engaged with the housing by a interferential engagement. After a long time, the engagement between the cover and the housing is prone to loose, hence the housing is easy to slide in relative to a predetermined position on the printed circuit board or drop off from the cover engaged by the vacuum suction device. In addition, for securely attaching the housing on the printed circuit board, there needs a powerful force for pressing the cover downwardly, which may destroy the terminal received therein.

Thus, there is a need to provide a new land grid connector assembly that overcomes the above-mentioned problems.

### SUMMARY OF THE INVENTION

Accordingly, an object of the present invention is to provide an electrical connector able to accurately locating the cover on the housing.

To fulfill the above-mentioned object, an electrical connector in accordance with a preferred embodiment comprises an insulative housing, a plurality terminals received in the housing, a cover mounted on the housing, and the cover defines a plurality of deformable members and projected elements. In addition, the cover defines a pair of locating plate on two ends thereof and the housing defines a pair of curved locating projection.

Relative to the present technology, the electrical connector in accordance with the preferred embodiment of the invention defines a plurality of deformable members on the sidewalls of the cover, which makes the engagement of the housing and the cover more closed. Furthermore, the locating plates of the cover engage with the curved locating projections of the housing, which makes the cover accurately locating on the housing. At last, the projected elements on inner walls of the cover not only transmits the force applied on the cover effectively to the whole electrical connector but also prevents the terminals received in the housing from being crashed by the cover.

Other objects, advantages and novel features of the present invention will become more apparent from the following detailed description when taken in conjunction with the accompanying drawings, in which:

### BRIEF DESCRIPTION OF THE DRAWINGS

FIG. 1 is an assembled view of an electrical connector in accordance with a preferred embodiment of the present invention;

FIG. 2 is an exploded, isometric view of terminal of the electrical connector shown in FIG. 1;

FIG. 3 is a cross-sectional view of the cover in the electrical connector of FIG. 1, in line of transverse symmetry direction.

### DESCRIPTION OF PREFERRED EMBODIMENT OF THE INVENTION

Reference will now be made to the drawings to describe the present invention in detail.

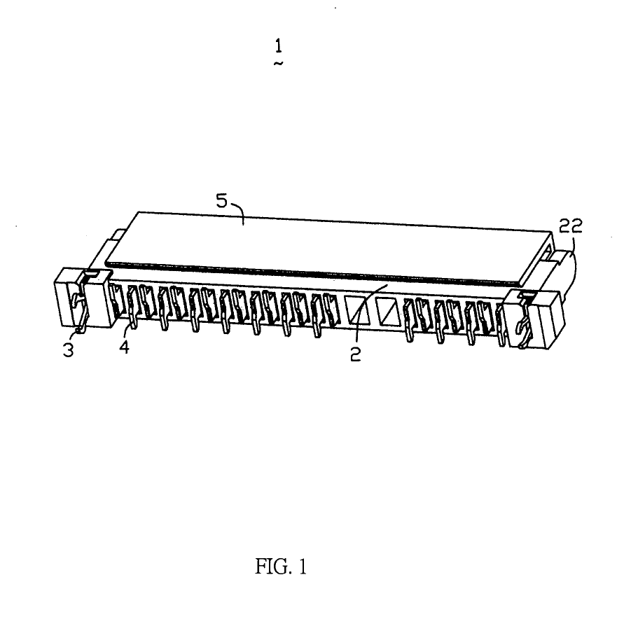

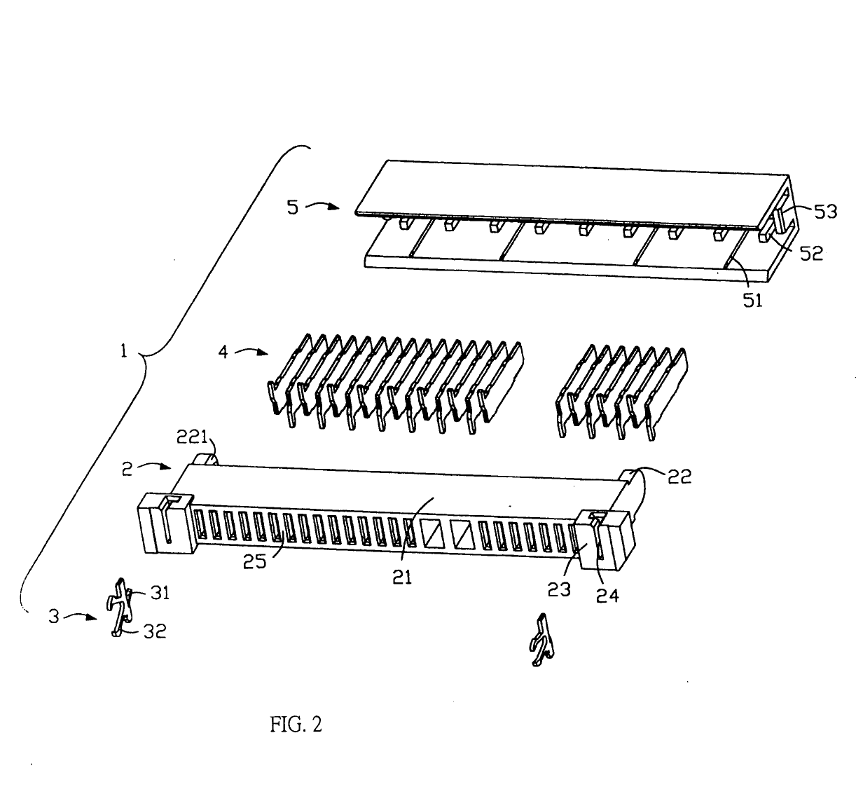

Referring to FIGS. 1-2, an electrical connector 1 in accordance with the preferred embodiment of the present invention provided for electrically connecting a application to a PCB includes a generally rectangular insulative housing 2, a pair of anchoring hooks 3, a multiplicity of terminals 4 received in the housing 2 and a cover 5 attached on the housing 2.

The housing 2 includes a rectangular base portion 21. The base portion 21 defines a pair of locating portions 22 on two ends thereof which define a slant surface 221 on an end thereof respectively. In addition, the base portion 21 defines a pair of rectangular base substrates 23 on two ends thereof and each base substrate 23 defines a recess 24 on a bottom surface thereof. The base portion 21 further defines a plurality of passageways 25 for receiving the terminals 4 therein between the two locating projections 22.

The anchoring hook 3 comprises a securing portion 31 and inverted U-shaped trip portion 32. The anchoring hook 3 is used for fixing the electrical connector on the printed circuit board.

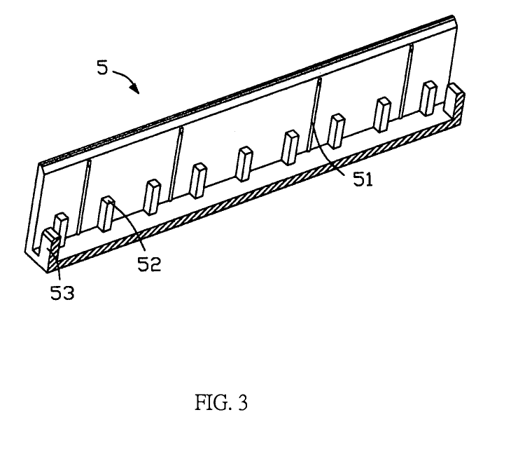

Referring to FIG. 3, the cover 5 is generally configured as U- shaped concave with sidewalls therearound and comprises a plurality of engaging element 51 and deformable members 52 on inner surfaces of the sidewalls. In addition, the cover 5 defines a pair of locating portion 53 on two ends thereof. The deformable members 51 are flushed with sidewalls of the cover 5 and the deformable members 52 extend from a bottom surface of the cover 5 to a position with a half height of the sidewall.

In assembly, the terminals 4 are firstly inserted into the passageways 25 of the housing 2. The anchoring hooks 3 are then mounted into the recesses 24 of the base substrate 23. At last, the cover 5 is attached to the housing 2 between the locating projections 22. The locating projections 22 can lead the locating portion 53 into the housing 2 by the slant surfaces 221 thereof. In addition, the engaging element 51 of the cover 5 can make the engagement between the cover 5 and the housing 2 more fittingly and reliably. In assembling electrical connector 1, the engaging element 51 abut against the upper surface of the housing 2 and the lengths of the engaging element 51 are enough to prevent the terminals 4 from contacting with the cover. The deformable members 52 are not interferentially engaged with terminals 4. The electrical connector 1 is locating on the printed circuit board by a vacuum suction device vacuuming an upper surface of the cover 5. Successively, the cover 5 is pressed downwardly toward the housing 2 by an outer force and the force transmitted by the deformable members 52 to the whole electrical connector 1 thereby the electrical connector 1 is secured mounted on the printed circuit board. At last, the anchoring hooks 3 connect the electrical connector 1 to the printed circuit board.

Although the present invention has been described with reference to a particular embodiment, it is not to be construed as being limited thereto. Various alterations and modifications can be made to the embodiment without in any way departing from the scope or spirit of the present invention as defined in the appended claims.

What is claimed is:

1. An electrical connector comprising:
an insulative housing comprising plurality of passageways therein;
a plurality of electrical terminals received in the housing;
a cover mounted on the housing;
wherein the cover includes a number of deformable members extending from an inner sidewall thereof.

2. The electrical connector as claimed in claim 1, wherein the cover further comprises a plurality of engaging elements.

3. The electrical connector as claimed in claim 1, the cover further defines a pair of locating portion projected on two ends thereof and the housing defines a pair of projections, and the locating portions engage with the projections.

4. The electrical connector as claimed in claim 3, wherein the projection each defines an arched slant surface on a lateral side thereof.

5. The electrical connector as claimed in claim 1, wherein the deformable members are spatially arranged on two opposite sidewalls and are of as high as a half of the sidewalls thereof.

6. The electrical connector as claimed in claim 5, wherein the deformable members abut against an upper surface and when the electrical connector assembled, the terminals do not contact with the cover.

7. The electrical connector as claimed in claim 6, further comprising an anchoring hook defining a securing portion and a trip portion.

8. The electrical connector as claimed in claim 7, wherein the trip portion is U-shaped.

9. An electrical connector comprising:
an insulative housing comprising plurality of passageways thereon;
a plurality of electrical terminals received in the housing;
a cover mounted on the housing;
wherein the cover includes a pair of locating portion projected on two ends thereof and the housing defines a pair projections, and the locating portions engage with the projections.

10. An electrical connector comprising:
an insulative housing comprising plurality of passageways thereon and a pair of recess indented in bottom surface thereof;
a plurality of electrical terminals received in the housing;
a cover mounted on the housing comprising a number of deformable member extending from a bottom surface thereof with a smaller length than sidewalls of the housing;
an anchoring hook received in the recess of the housing comprising a securing portion and a trip portion.

11. The electrical connector as claimed in claim 10, wherein the cover further comprises a number of engaging elements extending from a bottom surface of the housing for engaging with the housing.

12. The electrical connector as claimed in claim 10, the cover further defines a pair of locating portion projected on two ends thereof and the housing defines a pair of projections, and the locating portions engage with the projections.
